(19) United States
(12) Patent Application Publication
(10) Pub. No.: US 2026/0310030 A1
(43) Pub. Date: Oct. 8, 2026

(54) Display Device and Method

(71) Applicant: Envisics Ltd, Milton Keynes (GB)

(72) Inventors: Ian Bledowski, Milton Keynes (GB); Neil Collings, Milton Keynes (GB); Antariksh Saxena, Milton Keynes (GB)

(21) Appl. No.: 19/479,726

(22) PCT Filed: May 2, 2024
(86) PCT No.: PCT/EP2024/062126

§ 371 Date: Oct. 28, 2025

(30) Foreign Application Priority Data
May 18, 2023 (GB) 2307474.3

(51) Int. Cl. G02F 1/1362; G03H 1/02

(52) U.S. Cl. CPC G02F 1/136277; G02F 1/136204; G03H 1/02; G03H 2001/0224

(57) ABSTRACT

A method of fabricating a liquid crystal on silicon device such as a liquid crystal on silicon spatial light modulator. The method comprises a first set of steps. The first set of steps comprises forming a pixelated mirror layer on a silicon wafer; passivating the pixelated mirror layer by coating with dielectric; polishing the dielectric to expose pixel mirrors of the pixelated mirror layer; and applying a polymer layer to provide electrostatic protection. The first set of steps may be performed by a back-end wafer processing facility. The method comprises a second set of steps. The second set of steps comprises: removing the polymer layer to expose the pixel mirrors; and applying an alignment layer such as a polyimide alignment layer known in the art of liquid crystal devices. The second step of sets may be performed by an assembly house such as a silicon device assembly house.

### FIELD

The present disclosure relates to a silicon device and a method of fabricating a silicon device. More specifically, the present disclosure relates to a liquid crystal on silicon device and a method of fabricating the same. Yet more specifically, the present disclosure relates to a liquid crystal on silicon display device and a method of manufacturing the same. The silicon device may be a spatial light modulator such as a phase modulator. The display device may be optimised for holography.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”, and light detection and ranging, “LiDAR”, for example.

### SUMMARY

Aspects of the present disclosure are defined in the appended independent claims.

A display device according to the disclosure may be suitable for use in a picture generating unit or projector, such as a holographic projector. For example, the display device may be used in a system—such as a head-up display (HUD)—which is configured to display a picture to a viewer, without requiring the user to look away from their usual, or required, viewpoint. The display device may be particularly suitable for an HUD system comprised within a vehicle.

In the context of a picture generating unit or projector, the spatial light modulator must accurately modulate incident light according to a target image or hologram if the spatially modulated light is to correctly be encoded with that image or hologram. Spatial light modulators, such as liquid crystal on silicon spatial light modulators, are very sensitive electrical components and may be adversely affected by moisture and/or may be adversely affected be mechanical stress or strain. When a spatial light modulator is used in a relatively controlled environment having low humidity and stable temperature, ingress of moisture into the spatial light modulator may not be a concern. However, there is a need to use spatial light modulators in humid environments with an unstable or varying temperature. A particular example of such an environment is the inside of a vehicle or automobile.

Components to be used in vehicles must be able to perform acceptably over a wide range of temperatures and over a range of different humidities. For example, an electrical component located within the dashboard of a vehicle that is exposed to direct sunlight may be required to perform acceptably across a temperature ranging from as low as minus 40 degrees Celsius or lower to as high as 90 degrees Celsius or higher. An electrical component for use in a vehicle may be required to perform acceptably in a humidity ranging from 60% or less to 90% or more. The automotive industry typically apply strict testing methods to any electronic components to certify that the component is suitable before it can be used in a vehicle. These tests include thermal shock tests in which the display device is quickly transferred between two extreme temperatures. The thermal shock test may be repeated for 1000 cycles or more. The tests may comprise testing the electrical component after being exposed to a high humidity environment for 500 hours or more. These tests are far more rigorous than tests typically applied to electrical components not for use in the automotive industry. Furthermore, it is not enough for an assembled device to pass automotive standard tests. Typically, each individual electrical component is tested separately before being certified as being acceptable for us in a vehicle. So, in order for a HUD system to be suitable for use in a vehicle, the display device of that HUD system must perform acceptably in the unstable humid and unstable temperature environment of a vehicle and must be able to pass the automotive testing requirements.

A first aspect of the present disclosure is a method of fabricating a liquid crystal on silicon device. The method comprises a first set of steps. The first set of steps may be performed by a back-end wafer processing facility. The first set of steps comprises forming a pixelated mirror layer on a silicon wafer and passivating the pixelated mirror metal layer by coating with a passivation material. Pixels of the pixelated mirror layer extend or protrude from the silicon wafer (by e.g. 10 to 500 nm), and the passivation material extends a further distance beyond that (e.g. another 10 to 800 nm) such that surface features—for example, dips (i.e. a local decrease or minima in the coating thickness)—are formed in the passivation layer in correspondence (e.g. in alignment) with interpixel gaps between the metal pixels. Each surface feature (e.g. dip) may be immediately adjacent to a corresponding interpixel gap. Each interpixel gap may have a corresponding dip. Each dip and corresponding interpixel gap may be aligned in the direction of coating—e.g. in the vertical direction. For example, a minima of each surface feature may be substantially aligned (in the vertical direction) with the middle (in the horizonal direction) of the corresponding interpixel gap. In some examples, during coating, passivation material laterally flows into the interpixel gaps. The interpixel gaps may be at least as deep as the mirror metal layer thickness (in the direction of coating) before coating. The first set of steps further comprise polishing (e.g. CMP polishing) the passivation material to substantially remove the dips in the coating of the pixelated mirror layer. It is said that the so-called “dips” are removed by polishing to reflect that any evidence of a local decrease or minima in the thickness of the coating is removed by the step of polishing. For example, the step of polishing may comprise changing (e.g. reducing) the thickness of the coating of passivation layer until the minima is “polished-out”. The reader will be familiar with the idea of polishing-out surface features but, for the avoidance of doubt, if the minima extends e.g. d nm into the surface, the step of polishing may comprise reducing the thickness of the passivation layer by at least d nm. Polishing may expose the optical (i.e. light-receiving) surface of the pixels. Optionally, polishing may remove some of the pixel material. Alternatively, polishing may leave a thin coating of passivation material thereon the pixels. In some advantageous embodiments, the coating of passivation material left on the metal pixels after polishing is 10 to 50 nm. The inventors have found that this amount of passivation material (after polishing) optimizes the electric field loss across the liquid crystal cell. In a variation, an intermediate layer is provided on the pixels prior to coating with the passivation material. The intermediate layer may comprise an inorganic material such as a dielectric or e.g. a transition metal nitride such as TiN. The step of polishing may expose the intermediate layer. Optionally, some of the intermediate layer may be removed by the step of polishing. The inventors have validated these findings for an interpixel gap (width) at least in the range 50 to 500 nm but the present disclosure is not limited to this range. Each pixel mirror may be 0.5 to 100 micrometers (width) but the present disclosure is not limited to this range.

The method comprises a second set of steps. The second step of sets may be performed by an assembly house such as a silicon device assembly house. The second set of steps comprises applying an alignment layer. In some examples, the second set of steps are optional and the method may exclude these second set of steps.

In accordance with the present disclosure, an optically thin passivation layer is formed without dips over the interpixel gaps. A thin passivation layer is beneficial to (1) reduce field loss across the cell due to the dielectric layer thickness and (2) to reduce surface topology and ensure even flow of the LC material when filling. These issues may be tolerable with conventional display but the inventors have found that they cannot be tolerated with holography or phase modulation. Specifically, with conventional display (e.g. the display of an image using amplitude modulation), the additional resources (e.g. time and cost) required to apply a relatively thick passivation layer and then polish-down are not justified. However, the inventors have found that, in the case of holography and/or phase modulation, the benefits outweigh the cost. In particular, the inventors identified these dips as being responsible for a degradation in the performance of the device when used as a phase modulator particularly for holography.

Another aspect of the present disclosure is a method of fabricating a liquid crystal on silicon device. The method comprises a first set of steps. The first set of steps comprises forming a pixelated mirror layer on a silicon wafer; passivating the pixelated mirror layer by coating with dielectric; polishing the dielectric to expose pixel mirrors of the pixelated mirror layer; and applying a polymer layer to provide electrostatic protection. The first set of steps may be performed by a back-end wafer processing facility. The method comprises a second set of steps. The second set of steps comprises: removing the polymer layer to expose the pixel mirrors; and applying an alignment layer such as a polyimide alignment layer known in the art of liquid crystal devices. The second step of sets may be performed by an assembly house such as a silicon device assembly house. The person skilled in the art will appreciate that silicon devices are carefully protected (e.g. electrostatically protected) before being transferred by the back-end wafer processing facility to the assembly house. There is significant prejudice in the art to deviating from this practice. However, the inventors have recognised that when the silicon building block output by the back-end wafter processing facility will be used to assemble a liquid crystal on silicon device, it is not necessary to electrostatically protect the top/upper surface of the pixel electrodes-which, in some embodiments, are metal-because steps performed by the assembly house (particularly, the initial steps) are relatively low risk-compared to the fabrication of other silicon devices. Specifically, the risk of charge or voltage damage is relatively low. The inventors have found that prior art methods have a detrimental effect on display performance that is addressed by the present disclosure.

The LCOS pixel mirror surface (i.e. the pixelated mirror layer) is typically (but not always) passivated with a layer of passivation material such as SiO₂ and optionally SiN. The function of the layers is to protect the circuitry from unexpected charge/voltage spikes (SiO2) and to improve reflectivity (SiN). The back-end wafer processing includes a protective polymer layer which is removed at the assembly house, where an alignment layer is spun on the wafer. The inventors have identified that the risk of charge/voltage damage is minimal at the assembly house. Therefore, the passivation layer can be omitted. In addition, these layers act as a dielectric layer that decreases the electric field across the liquid crystal cell to the indium tin oxide glass. Holographic display requires the full voltage available to switch the liquid crystal as completely as possible.

The inventors have recognised that display performance—particularly holographic display performance—is improved if the passivation layer is absent or as thin as possible. This maximises the available electric field strength. The inventors identified the following issues whilst arriving at the improved method and device of the present disclosure. A thin (passivation) layer deposited without polishing results in a non-smooth topology that affects liquid crystal alignment and can introduce flow lines on (liquid crystal) filling. A thick (passivation) layer deposited and then polished back to a thin layer can be uneven with differing amounts of passivation remaining. This limits how thin you can go before the mechanical polishing exposes the mirror metal. No layers deposited means the interpixel gaps are unfilled and the topology is therefore worse than in an unpolished state.

In summary, the present disclosure relates to depositing a thick layer of passivation on top of the mirror so that the gaps are filled and then polishing back down to expose the mirror metal, therefore having a smooth surface with minimal topology and no masking of the electric field as the mirror metal will be exposed. Advantageously, no passivation material on mirror surface means no loss of electric field strength and a smoother surface means lower risk of (liquid crystal) flow lines.

In some embodiments, the thickness of the pixelated mirror layer and pixel mirrors after processing/polishing is equal to or greater than 50 nm. The term “thick” is used herein merely to reflect that the thickness before polishing is greater than the thickness after polishing. In some embodiments, polishing removes at least 5 nm of material such as at least 10 nm.

The second steps may further comprise, applying on the pixel mirrors, at least one selected from the group comprising: a glass cover structure; a spacing structure; and a common electrode layer such as an indium tin oxide, “ITO”, layer.

The step of passivating the pixelated mirror layer may comprise encapsulating the pixel mirrors with the dielectric.

A second aspect of the present disclosure is a method of preparing a silicon wafer for a liquid crystal on silicon assembly house. The method comprises: forming a pixelated mirror layer on silicon; passivating the pixelated mirror layer by coating with dielectric; polishing the dielectric to expose pixel mirrors of the pixelated mirror layer; and applying a polymer layer to provide electrostatic protection.

The method may further comprise: removing the polymer layer to expose the pixel mirrors; and applying an alignment layer.

The method may further comprises, applying on the pixel mirrors, at least one selected from the group comprising: a glass cover structure; a spacing structure; and a common electrode layer such as an ITO layer.

A third aspect of the present disclosure is a liquid crystal on silicon, “LCOS” device. The LCOS device comprises: a pixelated mirror layer on a silicon wafer, wherein interpixel gaps between pixel mirrors of the pixelated mirror surface comprise dielectric; and an alignment layer, wherein the alignment layer is in direct contact with the primary surfaces of the pixel mirrors. The primary surface of each pixel mirror may be a surface configured, in use, for light-receiving. The primary surface may also be considered a top surface or largest surface.

A fourth aspect of the present disclosure is a liquid crystal on silicon device characterized by the absence of a dielectric passivation layer between the pixelated mirror layer and the alignment layer.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2A illustrates a first iteration of an example Gerchberg-Saxton type algorithm;

FIG. 2B illustrates the second and subsequent iterations of the example Gerchberg-Saxton type algorithm;

FIG. 2C illustrates alternative second and subsequent iterations of the example Gerchberg-Saxton type algorithm;

FIG. 3 is a schematic of a reflective LCOS SLM;

FIG. 4 is a top view of a schematic of a spatial light modulator;

FIGS. 5A and 5B represent methods/devices in accordance with the prior art;

FIGS. 6A and 6B represent embodiments of the present disclosure; and

FIGS. 7A and 7B represent a further embodiment.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

### Optical Configuration

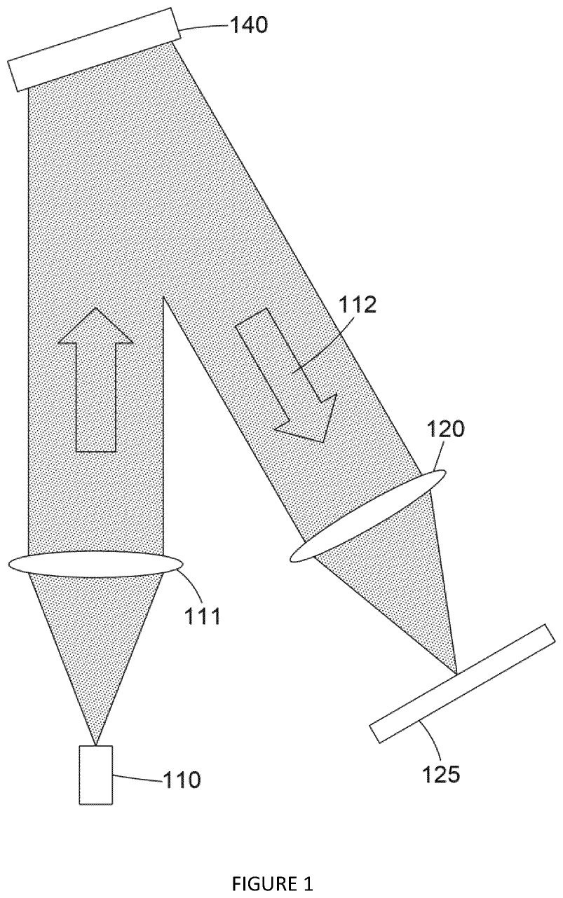

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125.

More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms.

A Fourier transform hologram may be calculated using an algorithm such as the Gerchberg-Saxton algorithm. Furthermore, the Gerchberg-Saxton algorithm may be used to calculate a hologram in the Fourier domain (i.e. a Fourier transform hologram) from amplitude-only information in the spatial domain (such as a photograph). The phase information related to the object is effectively “retrieved” from the amplitude-only information in the spatial domain. In some embodiments, a computer-generated hologram is calculated from amplitude-only information using the Gerchberg-Saxton algorithm or a variation thereof.

The Gerchberg Saxton algorithm considers the situation when intensity cross-sections of a light beam, I_{A}(x, y) and I_{B}(x, y), in the planes A and B respectively, are known and I_{A}(x, y) and I_{B}(x, y) are related by a single Fourier transform. With the given intensity cross-sections, an approximation to the phase distribution in the planes A and B, Ψ_{A}(x, y) and Ψ_{B} (x, y) respectively, is found. The Gerchberg-Saxton algorithm finds solutions to this problem by following an iterative process. More specifically, the Gerchberg-Saxton algorithm iteratively applies spatial and spectral constraints while repeatedly transferring a data set (amplitude and phase), representative of I_{A}(x, y) and I_{B}(x, y), between the spatial domain and the Fourier (spectral or frequency) domain. The corresponding computer-generated hologram in the spectral domain is obtained through at least one iteration of the algorithm. The algorithm is convergent and arranged to produce a hologram representing an input image. The hologram may be an amplitude-only hologram, a phase-only hologram or a fully complex hologram.

In some embodiments, a phase-only hologram is calculated using an algorithm based on the Gerchberg-Saxton algorithm such as described in British patent 2,498,170 or 2,501,112 which are hereby incorporated in their entirety by reference. However, embodiments disclosed herein describe calculating a phase-only hologram by way of example only. In these embodiments, the Gerchberg-Saxton algorithm retrieves the phase information Ψ[u, v] of the Fourier transform of the data set which gives rise to a known amplitude information T[x, y], wherein the amplitude information T[x, y] is representative of a target image (e.g. a photograph). Since the magnitude and phase are intrinsically combined in the Fourier transform, the transformed magnitude and phase contain useful information about the accuracy of the calculated data set. Thus, the algorithm may be used iteratively with feedback on both the amplitude and the phase information. However, in these embodiments, only the phase information Ψ[u, v] is used as the hologram to form a holographic representative of the target image at an image plane. The hologram is a data set (e.g. 2D array) of phase values.

In other embodiments, an algorithm based on the Gerchberg-Saxton algorithm is used to calculate a fully-complex hologram. A fully-complex hologram is a hologram having a magnitude component and a phase component. The hologram is a data set (e.g. 2D array) comprising an array of complex data values wherein each complex data value comprises a magnitude component and a phase component.

In some embodiments, the algorithm processes complex data and the Fourier transforms are complex Fourier transforms. Complex data may be considered as comprising (i) a real component and an imaginary component or (ii) a magnitude component and a phase component. In some embodiments, the two components of the complex data are processed differently at various stages of the algorithm.

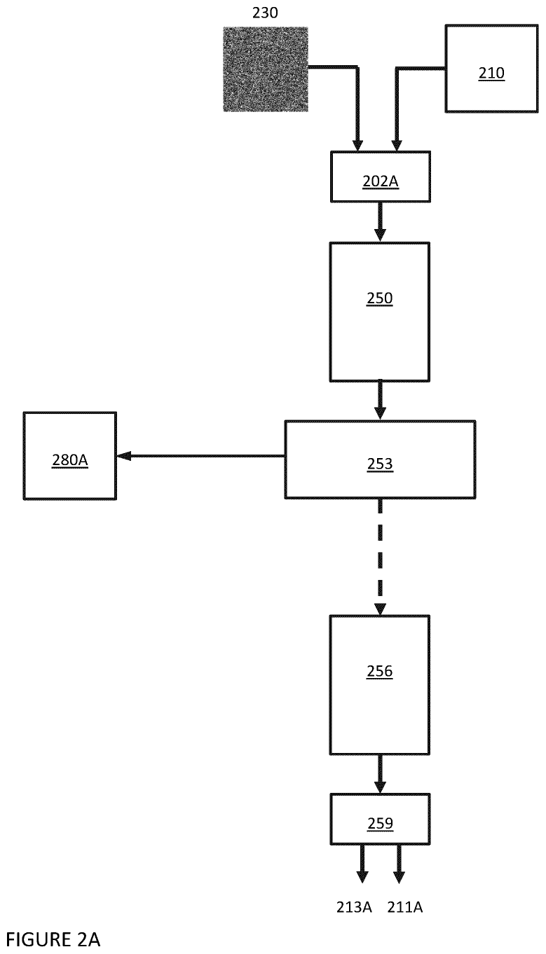

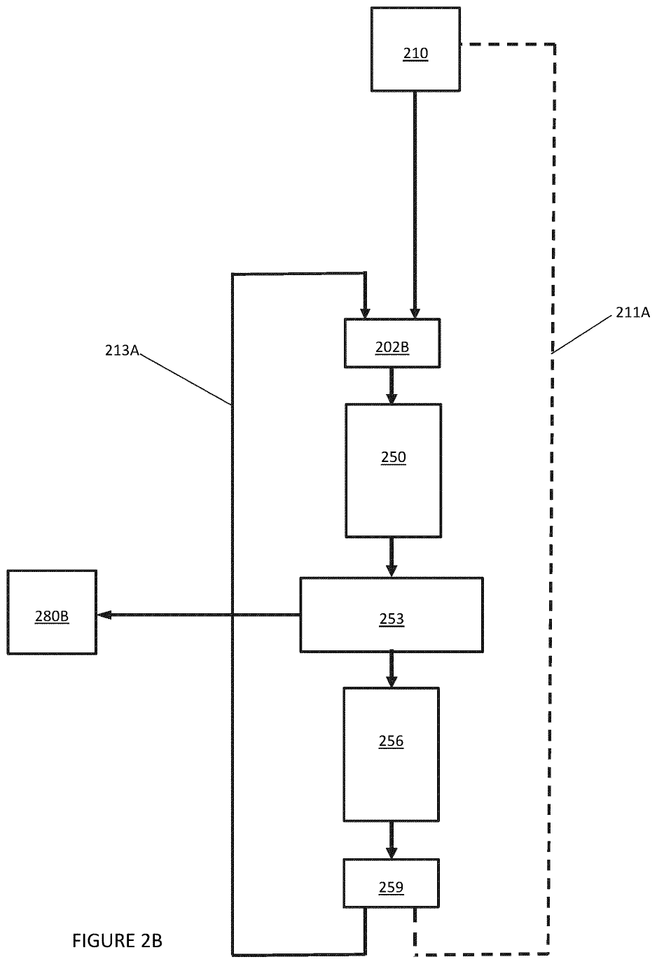

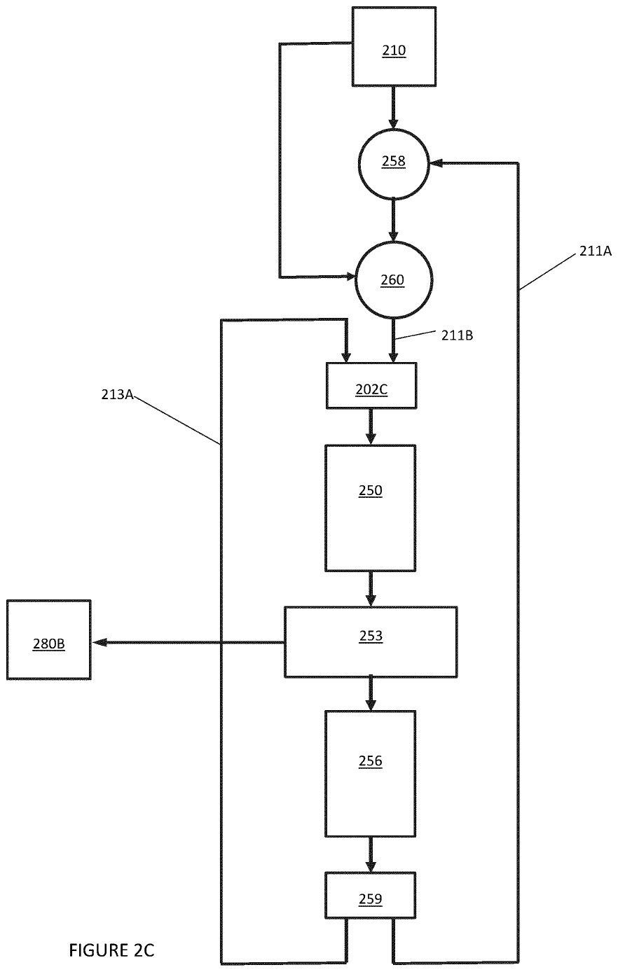

FIG. 2A illustrates the first iteration of an algorithm in accordance with some embodiments for calculating a phase-only hologram. The input to the algorithm is an input image 210 comprising a 2D array of pixels or data values, wherein each pixel or data value is a magnitude, or amplitude, value. That is, each pixel or data value of the input image 210 does not have a phase component. The input image 210 may therefore be considered a magnitude-only or amplitude-only or intensity-only distribution. An example of such an input image 210 is a photograph or one frame of video comprising a temporal sequence of frames. The first iteration of the algorithm starts with a data forming step 202A comprising assigning a random phase value to each pixel of the input image, using a random phase distribution (or random phase seed) 230, to form a starting complex data set wherein each data element of the set comprising magnitude and phase. It may be said that the starting complex data set is representative of the input image in the spatial domain.

First processing block 250 receives the starting complex data set and performs a complex Fourier transform to form a Fourier transformed complex data set. Second processing block 253 receives the Fourier transformed complex data set and outputs a hologram 280A. In some embodiments, the hologram 280A is a phase-only hologram. In these embodiments, second processing block 253 quantises each phase value and sets each amplitude value to unity in order to form hologram 280A. Each phase value is quantised in accordance with the phase-levels which may be represented on the pixels of the spatial light modulator which will be used to “display” the phase-only hologram. For example, if each pixel of the spatial light modulator provides 256 different phase levels, each phase value of the hologram is quantised into one phase level of the 256 possible phase levels. Hologram 280A is a phase-only Fourier hologram which is representative of an input image. In other embodiments, the hologram 280A is a fully complex hologram comprising an array of complex data values (each including an amplitude component and a phase component) derived from the received Fourier transformed complex data set. In some embodiments, second processing block 253 constrains each complex data value to one of a plurality of allowable complex modulation levels to form hologram 280A. The step of constraining may include setting each complex data value to the nearest allowable complex modulation level in the complex plane. It may be said that hologram 280A is representative of the input image in the spectral or Fourier or frequency domain. In some embodiments, the algorithm stops at this point.

However, in other embodiments, the algorithm continues as represented by the dotted arrow in FIG. 2A. In other words, the steps which follow the dotted arrow in FIG. 2A are optional (i.e. not essential to all embodiments).

Third processing block 256 receives the modified complex data set from the second processing block 253 and performs an inverse Fourier transform to form an inverse Fourier transformed complex data set. It may be said that the inverse Fourier transformed complex data set is representative of the input image in the spatial domain.

Fourth processing block 259 receives the inverse Fourier transformed complex data set and extracts the distribution of magnitude values 211A and the distribution of phase values 213A. Optionally, the fourth processing block 259 assesses the distribution of magnitude values 211A. Specifically, the fourth processing block 259 may compare the distribution of magnitude values 211A of the inverse Fourier transformed complex data set with the input image 510 which is itself, of course, a distribution of magnitude values. If the difference between the distribution of magnitude values 211A and the input image 210 is sufficiently small, the fourth processing block 259 may determine that the hologram 280A is acceptable. That is, if the difference between the distribution of magnitude values 211A and the input image 210 is sufficiently small, the fourth processing block 259 may determine that the hologram 280A is a sufficiently-accurate representative of the input image 210. In some embodiments, the distribution of phase values 213A of the inverse Fourier transformed complex data set is ignored for the purpose of the comparison. It will be appreciated that any number of different methods for comparing the distribution of magnitude values 211A and the input image 210 may be employed and the present disclosure is not limited to any particular method. In some embodiments, a mean square difference is calculated and if the mean square difference is less than a threshold value, the hologram 280A is deemed acceptable. If the fourth processing block 259 determines that the hologram 280A is not acceptable, a further iteration of the algorithm may be performed. However, this comparison step is not essential and in other embodiments, the number of iterations of the algorithm performed is predetermined or preset or user-defined.

FIG. 2B represents a second iteration of the algorithm and any further iterations of the algorithm. The distribution of phase values 213A of the preceding iteration is fed-back through the processing blocks of the algorithm. The distribution of magnitude values 211A is rejected in favour of the distribution of magnitude values of the input image 210. In the first iteration, the data forming step 202A formed the first complex data set by combining distribution of magnitude values of the input image 210 with a random phase distribution 230. However, in the second and subsequent iterations, the data forming step 202B comprises forming a complex data set by combining (i) the distribution of phase values 213A from the previous iteration of the algorithm with (ii) the distribution of magnitude values of the input image 210.

The complex data set formed by the data forming step 202B of FIG. 2B is then processed in the same way described with reference to FIG. 2A to form second iteration hologram 280B. The explanation of the process is not therefore repeated here. The algorithm may stop when the second iteration hologram 280B has been calculated. However, any number of further iterations of the algorithm may be performed. It will be understood that the third processing block 256 is only required if the fourth processing block 259 is required or a further iteration is required. The output hologram 280B generally gets better with each iteration. However, in practice, a point is usually reached at which no measurable improvement is observed or the positive benefit of performing a further iteration is out-weighted by the negative effect of additional processing time. Hence, the algorithm is described as iterative and convergent.

FIG. 2C represents an alternative embodiment of the second and subsequent iterations. The distribution of phase values 213A of the preceding iteration is fed-back through the processing blocks of the algorithm. The distribution of magnitude values 211A is rejected in favour of an alternative distribution of magnitude values. In this alternative embodiment, the alternative distribution of magnitude values is derived from the distribution of magnitude values 211 of the previous iteration. Specifically, processing block 258 subtracts the distribution of magnitude values of the input image 210 from the distribution of magnitude values 211 of the previous iteration, scales that difference by a gain factor α and subtracts the scaled difference from the input image 210. This is expressed mathematically by the following equations, wherein the subscript text and numbers indicate the iteration number:

$${R}_{n + 1} [ x , y ] = {F}^{′} \{ exp ( i {ψ}_{n} [ u , v ] ) \}$$

$${ψ}_{n} [ u , v ] = ∠ F \{ η \cdot exp ( i ∠ {R}_{n} [ x , y ] ) \}$$

$$η = T [ x , y ] - α ( \vert {R}_{n} [ x , y ] \vert - T [ x , y ] )$$

where:
F′ is the inverse Fourier transform;
F is the forward Fourier transform;
R[x, y] is the complex data set output by the third processing block 256;
T[x, y] is the input or target image;
∠ is the phase component;
Ψ is the phase-only hologram 280B;
η is the new distribution of magnitude values 211B; and
α is the gain factor.

The gain factor α may be fixed or variable. In some embodiments, the gain factor α is determined based on the size and rate of the incoming target image data. In some embodiments, the gain factor α is dependent on the iteration number. In some embodiments, the gain factor α is solely function of the iteration number.

The embodiment of FIG. 2C is the same as that of FIG. 2A and FIG. 2B in all other respects. It may be said that the phase-only hologram Ψ(u, v) comprises a phase distribution in the frequency or Fourier domain.

In some embodiments, the Fourier transform is performed using the spatial light modulator. Specifically, the hologram data is combined with second data providing optical power. That is, the data written to the spatial light modulation comprises hologram data representing the object and lens data representative of a lens. When displayed on a spatial light modulator and illuminated with light, the lens data emulates a physical lens—that is, it brings light to a focus in the same way as the corresponding physical optic. The lens data therefore provides optical, or focusing, power. In these embodiments, the physical Fourier transform lens 120 of FIG. 1 may be omitted. It is known how to calculate data representative of a lens. The data representative of a lens may be referred to as a software lens. For example, a phase-only lens may be formed by calculating the phase delay caused by each point of the lens owing to its refractive index and spatially-variant optical path length. For example, the optical path length at the centre of a convex lens is greater than the optical path length at the edges of the lens. An amplitude-only lens may be formed by a Fresnel zone plate. It is also known in the art of computer-generated holography how to combine data representative of a lens with a hologram so that a Fourier transform of the hologram can be performed without the need for a physical Fourier lens. In some embodiments, lensing data is combined with the hologram by simple addition such as simple vector addition. In some embodiments, a physical lens is used in conjunction with a software lens to perform the Fourier transform. Alternatively, in other embodiments, the Fourier transform lens is omitted altogether such that the holographic reconstruction takes place in the far-field. In further embodiments, the hologram may be combined in the same way with grating data—that is, data arranged to perform the function of a grating such as image steering. Again, it is known in the field how to calculate such data. For example, a phase-only grating may be formed by modelling the phase delay caused by each point on the surface of a blazed grating. An amplitude-only grating may be simply superimposed with an amplitude-only hologram to provide angular steering of the holographic reconstruction. The second data providing lensing and/or steering may be referred to as a light processing function or light processing pattern to distinguish from the hologram data which may be referred to as an image forming function or image forming pattern.

In some embodiments, the Fourier transform is performed jointly by a physical Fourier transform lens and a software lens. That is, some optical power which contributes to the Fourier transform is provided by a software lens and the rest of the optical power which contributes to the Fourier transform is provided by a physical optic or optics.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

Embodiments relate to Fourier holography and Gerchberg-Saxton type algorithms by way of example only. The present disclosure is equally applicable to Fresnel holography and Fresnel holograms which may be calculated by a similar method. The present disclosure is also applicable to holograms calculated by other techniques such as those based on point cloud methods.

### Light Modulation

A spatial light modulator may be used to display the diffractive pattern including the computer-generated hologram. If the hologram is a phase-only hologram, a spatial light modulator which modulates phase is required. If the hologram is a fully-complex hologram, a spatial light modulator which modulates phase and amplitude may be used or a first spatial light modulator which modulates phase and a second spatial light modulator which modulates amplitude may be used.

In some embodiments, the light-modulating elements (i.e. the pixels) of the spatial light modulator are cells containing liquid crystal. That is, in some embodiments, the spatial light modulator is a liquid crystal device in which the optically-active component is the liquid crystal. Each liquid crystal cell is configured to selectively-provide a plurality of light modulation levels. That is, each liquid crystal cell is configured at any one time to operate at one light modulation level selected from a plurality of possible light modulation levels. Each liquid crystal cell is dynamically-reconfigurable to a different light modulation level from the plurality of light modulation levels. In some embodiments, the spatial light modulator is a reflective liquid crystal on silicon (LCOS) spatial light modulator but the present disclosure is not restricted to this type of spatial light modulator.

A LCOS device provides a dense array of light modulating elements, or pixels, within a small aperture (e.g. a few centimetres in width). The pixels are typically approximately 10 microns or less which results in a diffraction angle of a few degrees meaning that the optical system can be compact. It is easier to adequately illuminate the small aperture of a LCOS SLM than it is the larger aperture of other liquid crystal devices. An LCOS device is typically reflective which means that the circuitry which drives the pixels of a LCOS SLM can be buried under the reflective surface. The results in a higher aperture ratio. In other words, the pixels are closely packed meaning there is very little dead space between the pixels. This is advantageous because it reduces the optical noise in the replay field. A LCOS SLM uses a silicon backplane which has the advantage that the pixels are optically flat. This is particularly important for a phase modulating device.

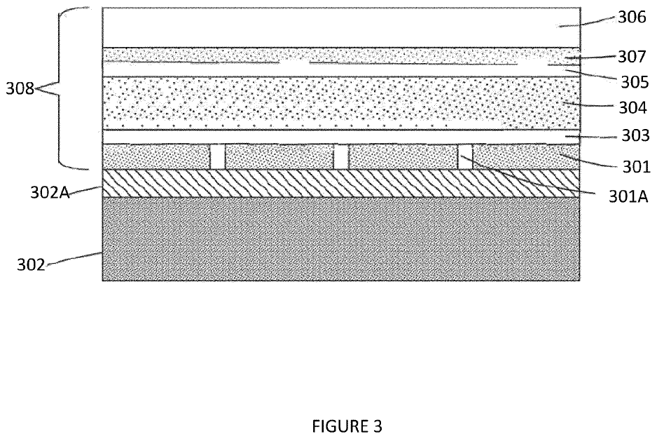

A suitable LCOS SLM is described below, by way of example only, with reference to FIG. 3. An LCOS device is formed using a single crystal silicon substrate 302. It has a 2D array of square planar aluminium electrodes 301, spaced apart by a gap 301a, arranged on the upper surface of the substrate. Each of the electrodes 301 can be addressed via circuitry 302a buried in the substrate 302. Each of the electrodes forms a respective planar mirror. An alignment layer 303 is disposed on the array of electrodes, and a liquid crystal layer 304 is disposed on the alignment layer 303. A second alignment layer 305 is disposed on the planar transparent layer 306, e.g. of glass. A single transparent electrode 307 e.g. of ITO is disposed between the transparent layer 306 and the second alignment layer 305.

Each of the square electrodes 301 defines, together with the overlying region of the transparent electrode 307 and the intervening liquid crystal material, a controllable phase-modulating element 308, often referred to as a pixel. The effective pixel area, or fill factor, is the percentage of the total pixel which is optically active, taking into account the space between pixels 301a. By control of the voltage applied to each electrode 301 with respect to the transparent electrode 307, the properties of the liquid crystal material of the respective phase modulating element may be varied, thereby to provide a variable delay to light incident thereon. The effect is to provide phase-only modulation to the wavefront, i.e. no amplitude effect occurs.

The described LCOS SLM outputs spatially modulated light in reflection. Reflective LCOS SLMs have the advantage that the signal lines, gate lines and transistors are below the mirrored surface, which results in high fill factors (typically greater than 90%) and high resolutions. Another advantage of using a reflective LCOS spatial light modulator is that the liquid crystal layer can be half the thickness than would be necessary if a transmissive device were used. This greatly improves the switching speed of the liquid crystal (a key advantage for the projection of moving video images). However, the teachings of the present disclosure may equally be implemented using a transmissive LCOS SLM.

### Display Device

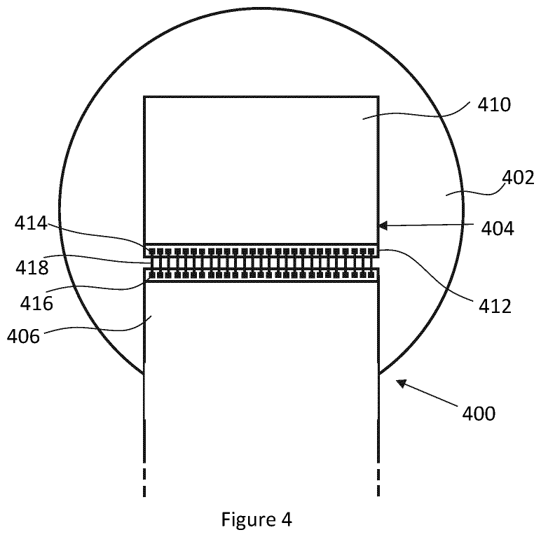

A spatial light modulator, such as the spatial light modulator described in relation to FIG. 3, can be packaged as a display device which, in some embodiments, can be provided as part of a HUD system for use in a vehicle. The display device may be a component that is manufactured separately as a standalone component and then fitted into an appropriate the HUD system when the HUD system is assembled. FIG. 4 shows a schematic top view of such a display device 400.

The display device 400 comprises a substrate 402 in the form of ceramic carrier and a spatial light modulator 404 mounted on the substrate 402. In this example, the spatial light modulator 404 is an SLM LCOS as described in relation to FIG. 3. However, it will be clear to the skilled person that other spatial light modulators may take the place of the LCOS SLM of FIG. 3 in the display device. The substrate 402 (of the display device) shown in FIG. 4 is different to the substrate 302 (of the LCOS SLM) shown in FIG. 3. An adhesive layer (not shown in the figures) secures the spatial light modulator 404 to the substrate 402. In particular, the adhesive layer secures the substrate 302 of the spatial light modulator 404 to the substrate 402 of the display device. The substrate 402 comprises a heat dissipation portion which is directly below the spatial light modulator 404 and so cannot be seen in FIG. 4. The heat dissipating portion of the substrate 402 is a portion comprising a metal such as aluminium which is arranged to conduct heat away from the spatial light modulator.

A connector 406 is connected to the spatial light modulator 404 which, in this example, is a flexible printed cable capable but may alternatively be a flat flex connector or a flexible printed circuit board. Only an end portion of the connector 406 is shown in FIG. 4. The connector 406 extends from the end portion and away from the spatial light modulator 404. This is represented by the broken lines in FIG. 4. In some embodiments, the other end of the connector 406 (not shown in figures) is connected to another part of a HUD system. In some examples, the connector 406 is directly or indirectly electrically connected to a controller of the HUD system such as a real-time engine arranged to receive image data, calculate holograms in real-time and display the holograms on the spatial light modulator via the connector 406.

The spatial light modulator 404 comprises a light modulating region 410 and an electrical connection region 412 (or wire bond region). From the perspective shown, the light modulating region 410 of FIG. 4 corresponds to the planar transparent glass layer 306 of FIG. 3. The electrical connection region 412 is used to connect the spatial light modulator 404 to the rest of the HUD system via the connector 406. The electrical connection region 412 comprises a plurality of (in this example, 28, but the present disclosure is not limited thereto) first contact portions 414. Each first contact portion 414 is electrically connected to circuitry 302a described in FIG. 3.

The spatial light modulator 404 comprises a plurality of second contact portions 416. There is one second contact portion 416 for each first contact portion 414 so, in this example, there are 28 second contact portions 416. Each first contact portion 414 is connected to a respective second contact portion 416 via a wire bond 418 such that there are also 28 wire bonds in this example. In one embodiment, the wire bonds 418 are formed of aluminium doped with silicon and have a thickness of 32 micrometres. The wire bonds 418 are formed by wedge bonding. However, the present disclosure is not limited to a particular type of wire bonding or wire bonds having a particular size or formed of a particular material.

In one example, during use of the display device 400, a computer-generated hologram is generated by the controller. The spatial light modulator 400 receives the computer-generated hologram via the connector 406, the second contact portions 416, the wire bonds 418 and then the first contact portion 414 before being received by circuitry 302a (as described in relation to FIG. 3). The array of pixels of the spatial light modulator 400 is then encoded with the hologram generated by the controller. As described above, the array of pixels of the spatial light modulator 400 is then illuminated with light from a light source such as a laser or laser diode such that light is incident on the spatial light modulator. The light is then modulated in accordance with the hologram.

The spatial light modulator 400 is a very sensitive electrical component. Furthermore, the wire bonds 418 and the first and second contact portions 414,416 are delicate. These features may be adversely effected when exposed to the atmosphere. A particular problem is the ingress of the moisture into the spatial light modulator or electrical connections. This can adversely affect the quality of the holograms displayed on the spatial light modulator 400 and so adversely affect the final image viewed by a user when the spatial light modulator 400 is part of a head-up display.

### Processing of the Passivation Layer

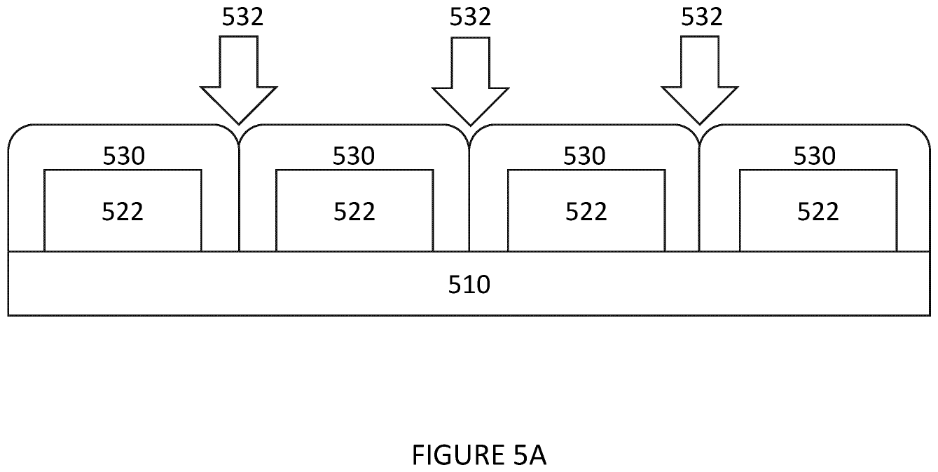

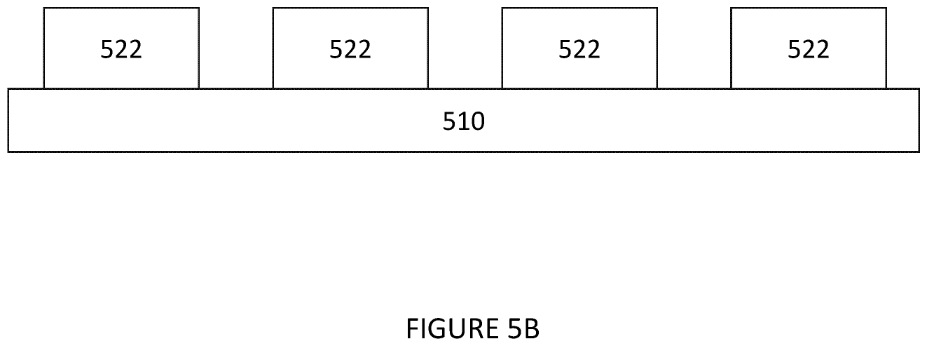

FIG. 5A represents a first silicon device formed by a first inferior method in accordance with the state of the art prior to the present invention. FIG. 5A shows a lower layer 510, a pixelated mirror layer comprising a plurality of pixel mirrors 522, and a passivation component 530 comprising a plurality of dips 532. The device has been formed by depositing the passivation component 530 as a layer on the pixelated mirror layer. The pixelated mirrors of the pixelated mirror layer are metal. The inventors have found that this structure exhibits poor topography. Dips 532 are present over the interpixel gaps between adjacent pixel mirrors. But the interpixel gaps are full of passivation material. The person skilled in the art that the first silicon device shown in FIG. 5A is incomplete. That is, further fabrication steps are required but these are not described in detail herein because they are not essential to understanding the new concept.

FIG. 5B represents a second silicon device formed by a second inferior method in accordance with the state of the art prior to the present invention. FIG. 5B also shows a lower layer 510 and a pixelated mirror layer comprising a plurality of pixel mirrors 522. FIG. 5B is characterized by the absence of a passivation component. The pixel mirrors are uncovered. Interpixel gaps are pronounced and, the inventors have found, cause 1/poor deposition of any liquid crystal alignment layer and 2/flow lines in the liquid crystal.

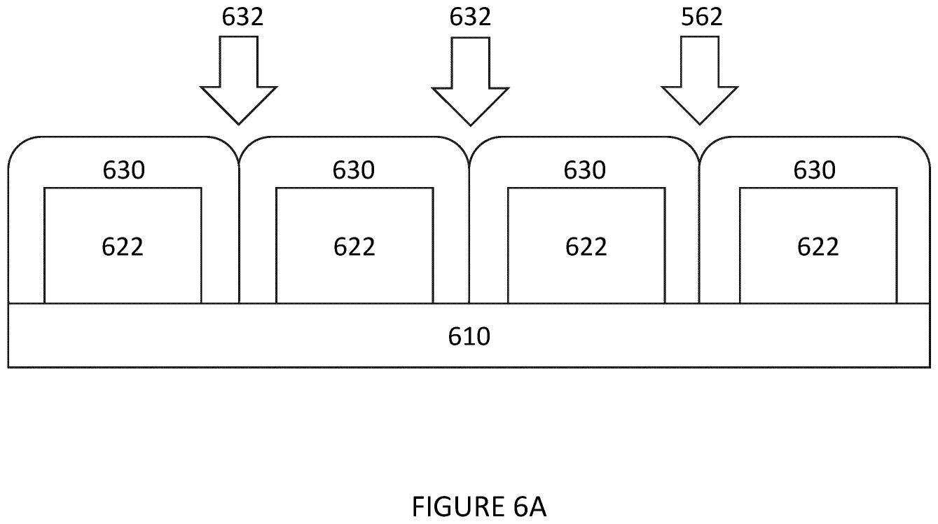

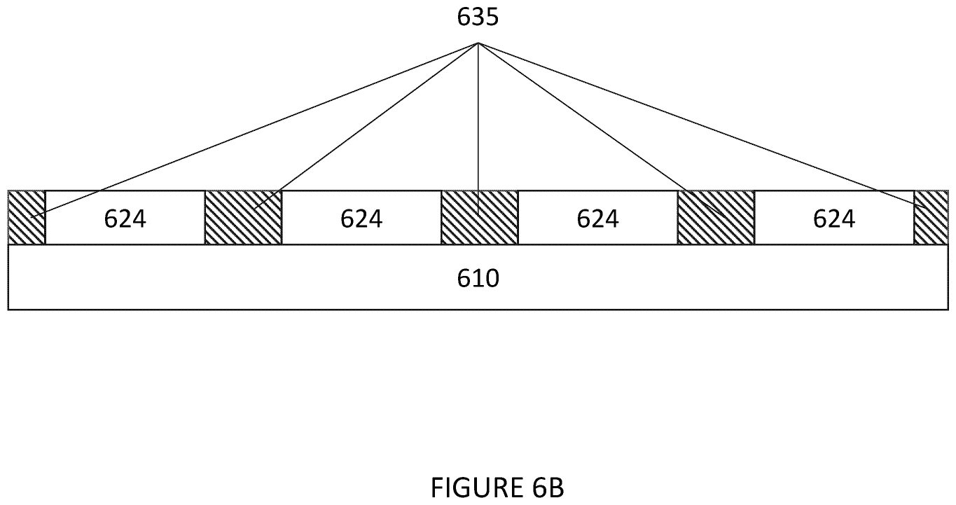

FIGS. 6A and 6B represents embodiments of the present disclosure. FIG. 6A represents first steps of a method. The first steps may be steps of a back-end silicon wafer processing method. The first steps may be performed by a silicon foundry. FIG. 6A shows a lower layer 610, a pixelated mirror layer 620 comprising a plurality of pixel mirrors 622, and a passivation component 630 comprising a plurality of dips 632. The device has been formed by depositing the passivation component 630 as a layer on the pixelated mirror layer 620. The pixelated mirrors of the pixelated mirror layer are metal. The inventors have found that this structure exhibits poor topography. Dips 632 are present over the interpixel gaps between adjacent pixel mirrors. But the interpixel gaps are full of passivation material. The person skilled in the art that the silicon device shown in FIG. 6A is incomplete. That is, further fabrication steps are required but these are not described in detail herein because they are not essential to understanding the new concept. Notably, the passivation layer is relatively thick and the pixelated mirror layer/pixel mirrors are relatively thick at least compared to FIG. 5B.

FIG. 6B represents further steps of the method in accordance with embodiments. Polishing is used to remove the upper few nanometres of the surface so that all the upper area of the passivation gets removed and the pixel mirrors are cut into. The pixel mirrors 624 are thinned and topology is removed to make the surface flatter. The interpixel gaps between adjacent pixel mirrors 624 is filled with passivation material 635.

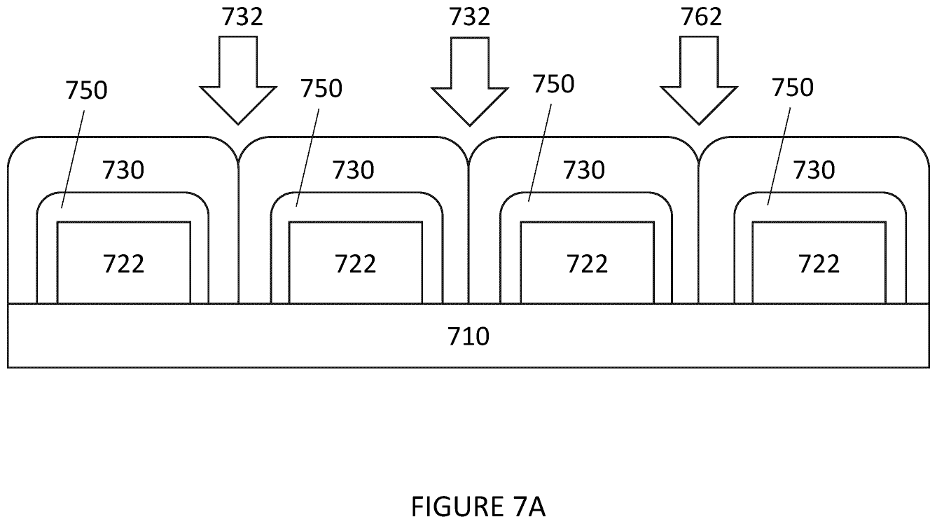

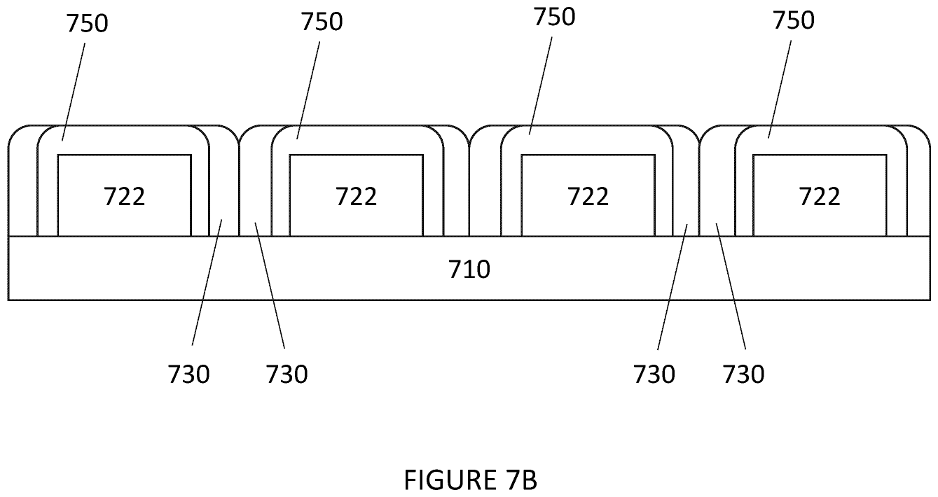

FIGS. 7A and 7B show a further embodiment. FIG. 7A represents first steps of a method. The first steps may be steps of a back-end silicon wafer processing method. The first steps may be performed by a silicon foundry. FIG. 7A shows a lower layer 710, a pixelated mirror layer comprising a plurality of pixel mirrors 722 and a passivation component 730 comprising a plurality of dips 732. In this embodiment, the pixelated mirror layer is covered with a thin layer of TiN before the passivation process (i.e. application of the passivation layer 730). In other words, a first part of the method comprises first deposit a thin layer of TiN to cover the metal then follow up with depositing the passivation in thick layer on thicker than final intended mirror metal thickness. Topology will be poor and dips will be present over interpixel gap, but the gap will be full of passivation material.

FIG. 7B represents further steps of the method in accordance with some embodiments. The additional thin layer of TiN allows polishing down towards the pixel, optionally, stopping just short thereof. Advantageously, this leaves the metal covered with TIN at the end, stopping oxidation, and in some cases improving reflectivity. Further advantageously, this helps absorb polishing tolerances across the wafer. The interpixel gaps between adjacent pixel mirrors 722 remain filled with passivation material 730. In other words, a second part of method comprises, next, use e.g. CMP polishing to remove the upper few nm of surface so that all the upper area of passivation gets removed and we start cutting into the TiN passivation just above the mirror metal. The mirror may be thinned but, in some embodiments, it remains greater than or equal to 50 nm so that reflectivity does not drop. Topology is removed to make it flatter.

### ADDITIONAL FEATURES

Embodiments refer to an electrically-activated LCOS spatial light modulator by way of example only. The teachings of the present disclosure may equally be implemented on any spatial light modulator capable of displaying a computer-generated hologram in accordance with the present disclosure such as any electrically-activated SLMs, optically-activated SLM, digital micromirror device or microelectromechanical device, for example.

Examples describe illuminating the SLM with visible light but the skilled person will understand that the light sources and SLM may equally be used to direct infrared or ultraviolet light, for example, as disclosed herein. For example, the skilled person will be aware of techniques for converting infrared and ultraviolet light into visible light for the purpose of providing the information to a user. For example, the present disclosure extends to using phosphors and/or quantum dot technology for this purpose.

Some embodiments describe 2D holographic reconstructions by way of example only. In other embodiments, the holographic reconstruction is a 3D holographic reconstruction. That is, in some embodiments, each computer-generated hologram forms a 3D holographic reconstruction.

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A method of fabricating a liquid crystal on silicon device, the method comprising first steps of:
forming a pixelated mirror layer on a silicon wafer;
passivating the pixelated mirror layer by coating with a passivation material, wherein pixels of the pixelated mirror layer protrude from the silicon wafer such that dips in the coating of passivation material are formed in correspondence with interpixel gaps;
polishing the passivation material to remove the dips in the coating of the pixelated mirror layer; and
wherein the method comprises second steps of:
applying an alignment layer.

2. The method of claim 1, wherein a thickness of the passivation material before polishing is greater than about 50 nm.

3. The method of claim 1, wherein a thickness of the passivation material before polishing is less than about 800 nm.

4. The method of claim 1, wherein a thickness of the passivation material after polishing is between about 10 to about 50 nm.

5. The method of claim 1, wherein an interpixel gap is between about 50 to about 500 nm.

6. The method of claim 1, wherein the second steps further comprise;
applying, on pixel mirrors of the pixelated mirror layer, at least one selected from a group comprising: a glass cover structure; a spacing structure; and an ITO layer.

7. The method of claim 1, wherein passivating the pixelated mirror layer comprises encapsulating pixel mirrors of the pixelated mirror layer with dielectric.

8. A method of preparing a silicon wafer for a liquid crystal on silicon assembly house, the method comprising:
forming a pixelated mirror layer on silicon;
passivating the pixelated mirror layer by coating with dielectric;
polishing the dielectric to expose pixel mirrors of the pixelated mirror layer; and
applying a polymer layer to provide electrostatic protection.

9. The method of claim 8, further comprising:
removing the polymer layer to expose the pixel mirrors; and
applying an alignment layer.

10. The method of claim 9, further comprising:
applying on the pixel mirrors at least one selected from a group comprising: a glass cover structure; a spacing structure; and an ITO layer.

11. A liquid crystal on silicon device comprising:
a pixelated mirror layer on a silicon wafer, wherein interpixel gaps between pixel mirrors of the pixelated mirror layer comprise dielectric; and
an alignment layer, wherein the alignment layer is in direct contact with one or more optical surfaces of the pixel mirrors.

12. A liquid crystal on silicon device comprising:
an alignment layer interfacing liquid crystal material; and
a pixelated mirror layer configured to reflect light, wherein the liquid crystal on silicon device lacks a dielectric passivation layer between the pixelated mirror layer and the alignment layer.

13. The liquid crystal on silicon device of claim 11, wherein interpixel gaps between pixel mirrors have a width of between about 50 to about 500 nm.

14. The liquid crystal on silicon device of claim 12, wherein interpixel gaps between pixel mirrors of the pixelated mirror layer have a width of between about 50 to about 500 nm.

15. The liquid crystal on silicon device of claim 12, wherein the pixelated mirror layer comprises pixel mirrors having exposed optical surfaces in direct contact with the alignment layer.
